(19) United States
(12) Patent Application Publication
(10) Pub. No.: US 2009/0080538 A1
(43) Pub. Date: Mar. 26, 2009

(54) Method and Apparatus for Decoding a Video Signal

(75) Inventors: Fu-Chin Shen, Hsichih (TW); Chia-Cheng Liu, Hsichih (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Hsichih (TW)

(21) Appl. No.: 11/858,329

(22) Filed: Sep. 20, 2007

(51) Int. Cl. H04N 11/02

(52) U.S. Cl. 375/240.28; 375/E07.076

(57) ABSTRACT

An apparatus for transmitting a video signal has a receiver, a processor and a multiplexer. The receiver receives the video signal and separates a composite sync signal from the video signal. The processor generates a vertical sync signal and a selecting signal with reference to timing characteristics of the composite sync signal. The multiplexer generates a horizontal sync signal by selectively outputting the composite sync signal when the selecting signal is at a first logic level and outputting a reference signal when the selecting signal is at a second logic level. A method for transmitting a video signal is also disclosed.

### BACKGROUND

1. Field of Invention

The present invention relates to the video signal transmission. More particularly, the present invention relates to a method and apparatus for decoding video signals with composite H-Sync and V-Sync signals.

2. Description of Related Art

FIG. 1 illustrates a conventional KVM extender 100, which is used to transmit a video signal, a keyboard signal (not shown) and a mouse signal (not shown) from a computer 112 to a monitor 114, a keyboard (not shown) and a mouse (not shown) via a cable 106. The KVM extender 100 includes a dongle device 102 and a console device 104 coupled to the computer 112 and the monitor 114, keyboard and mouse, respectively. Generally, the video signal provided from the computer 112 contains a horizontal sync signal (H), a vertical sync signal (V), a red color signal (R), a green color signal (G) and a blue color signal (B), and the cable 106 connecting the dongle and console devices 102 and 104, such as a CAT. 5 cable, has four pairs of wires.

The keyboard signal and the mouse signal must take at least one pair of wires for transmission. In order to transmit the five signals by the remaining three pairs of wires, the dongle device 102 of the conventional KVM extender 100 typically combines (or mixes) the horizontal sync signal (H) and the vertical sync signal (V) with the blue color signal (B) and the red color signal (R), respectively, and the console device 104 then separates (or restores) the horizontal sync signal (H) and the vertical sync signal (V) from the two combined color signals (H+B) and (V+R) after the cable 106.

By this conventional architecture, if the video signal provided from a computer to the dongle device 102 originally contains a composite sync signal (H+V), such as the video signal used in a Sun workstation, the dongle device 102 has to firstly decode the horizontal and vertical sync signals from the composite sync signal (H+V), and then combine each of the two sync signals (H) and (V) into one of the three color signals (R), (G) and (B) for transmitting through the cable 106 as mentioned above.

### SUMMARY

According to one embodiment of the present invention, a method for decoding a video signal is disclosed. The video signal is received, and a composite sync signal is separated from the video signal. A vertical sync signal and a selecting signal are generated with reference to timing characteristics of the composite sync signal. A horizontal sync signal is then generated by selectively outputting the composite sync signal when the selecting signal is at a first logic level, and outputting a reference signal when the selecting signal is at a second logic level.

According to another embodiment of the present invention, an apparatus for decoding a video signal comprises a receiver, a processor and a multiplexer. The receiver receives the video signal and separates a composite sync signal from the video signal. The processor generates a vertical sync signal and a selecting signal with reference to timing characteristics of the composite sync signal. The multiplexer generates a horizontal sync signal by selectively outputting the composite sync signal when the selecting signal is at a first logic level and outputting a reference signal when the selecting signal is at a second logic level.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a conventional KVM extender, which is used to transmit a video signal, a keyboard signal, and a mouse signal from a computer to a monitor, a keyboard and a mouse via a cable;

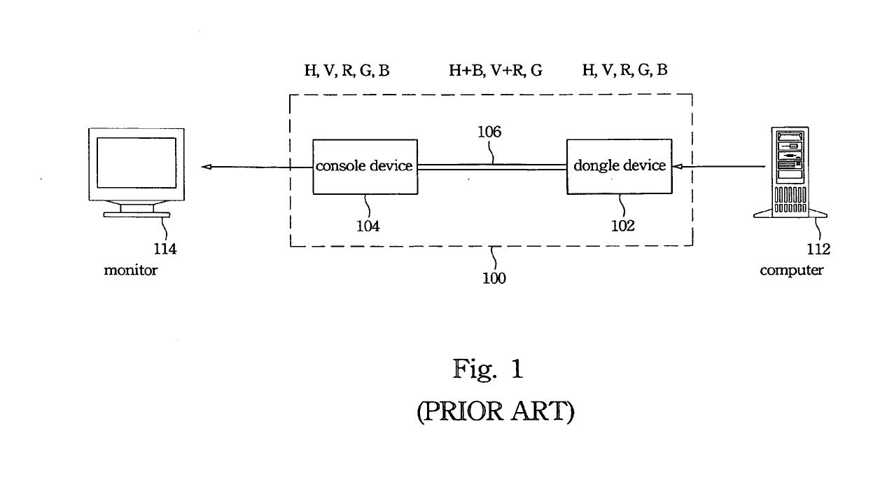

FIG. 2 is a system for transmitting video signals according to one example consistent with the present invention;

FIG. 3 is an apparatus for receiving the video signal, which may be applied in the second device in FIG. 2, according to one example consistent with the present invention;

FIG. 4 is a flow chart of a method for receiving the video signal, which may be performed by the second device in FIG. 2, according to one example consistent with the present invention;

FIG. 5A illustrates the timing diagram of the first-type composite sync signal, and its corresponding horizontal and vertical sync signals;

FIG. 5B illustrates the timing diagram of the second-type composite sync signal, and its corresponding horizontal and vertical sync signals;

FIG. 6A illustrates the timing diagram of the first-type composite sync signal, the reference signal, the selecting signal, and the horizontal sync signal according to one example consistent with the present invention; and

FIG. 6B illustrates the timing diagram of the second-type composite sync signal, the detection signal, the XOR signal, the reference signal, the selecting signal, and the horizontal sync signal according to one example consistent with the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

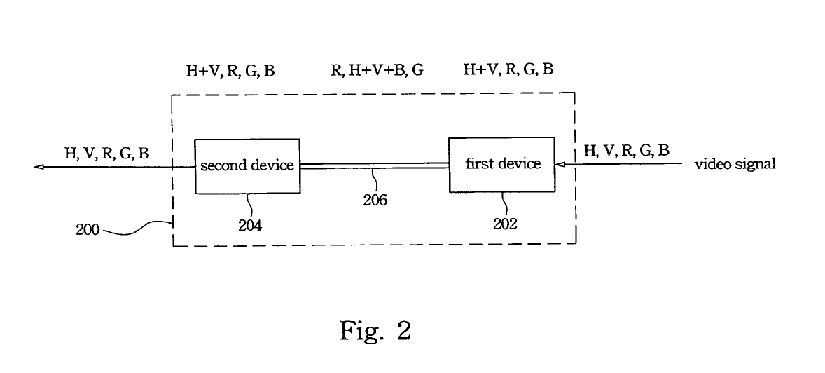

FIG. 2 is a system 200 for transmitting video signals according to one example consistent with the present invention. The system 200 includes, a first device 202 and a second device 204. The first device 202 receives the video signal, for example, from a computer device, to encode a horizontal sync signal (H) and a vertical sync signal (V) of the video signal into a composite sync signal (H+V), and combines the composite sync signal (H+V) into one of three color signals (R), (G) and (B) of the video signal, thus obtaining a combined color signal (for example, H+V+B). It is noted that the composite sync signal (H+V) encoded by the first device 202 can be combined into any of the three color signals, whether the red, green, or blue color signal, which is not limited by this example as illustrated in FIG. 2.

The first device 202 then transmits the three color signals (including the combined color signal) (R), (G) and (H+V+B), via the cable 206, or an optical fiber, or even wirelessly. The second device 204 is in communication with the first device 202, may via the cable 306, or the optical fiber, or even wirelessly. The second device 204 separates the composite sync signal (H+V) from the combined color signal (H+V+B), and separates (decodes) the horizontal sync signal (H) and the vertical sync signal (V) from the composite sync signal (H+V), for outputting to a monitor, for example.

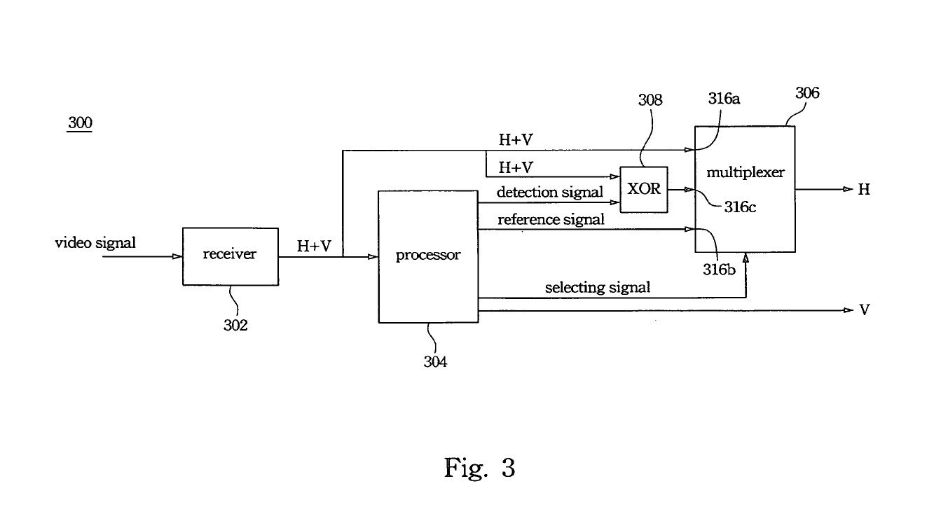

FIG. 3 is an apparatus 300 for receiving the video signal according to one example consistent with the present invention, which may be applied in the second device 204 in FIG. 2. The apparatus 300 includes, a receiver 302, a processor 304 and a multiplexer 306. The receiver 302 receives the video signal, for example, from the first device 202 in FIG. 2, and picks a composite sync signal (H+V) from the video signal. The processor 304 generates a vertical sync signal (V) and a selecting signal with reference to timing characteristics of the composite sync signal (H+V). The multiplexer 306 generates a horizontal sync signal (H) by selectively outputting the composite sync signal (H+V) when the selecting signal is at a first logic level and outputting a reference signal when the selecting signal is at a second logic level.

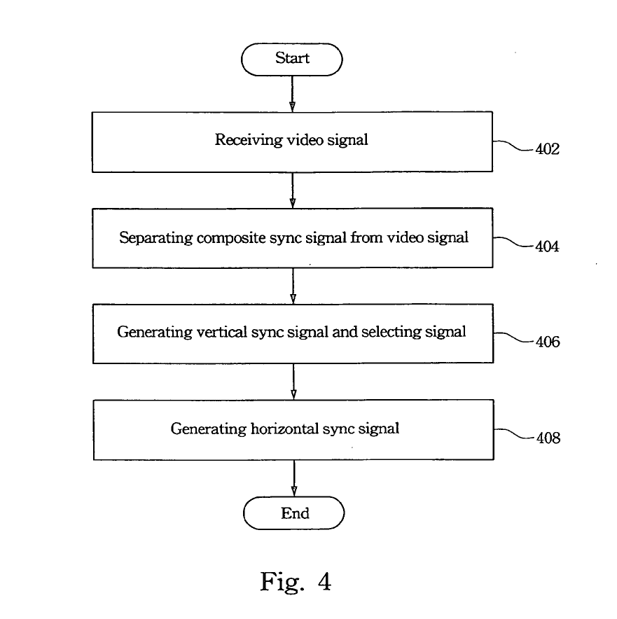

FIG. 4 is a flow chart of a method for transmitting the video signal according to one example consistent with the present invention, which may be performed by the second device 204 in FIG. 2. The video signal is firstly received (step 402), and a composite sync signal (H+V) is separated from the video signal (step 404). A vertical sync signal (V) and a selecting signal are generated with reference to timing characteristics of the composite sync signal (H+V) (step 406). A horizontal sync signal (H) is then generated by selectively outputting the composite sync signal (H+V) when the selecting signal is at a first logic level, and outputting a reference signal when the selecting signal is at a second logic level (step 408).

The following description is made with reference to FIGS. 3 and 4. The receiver 302 can receive the video signal transmitted from the first device 202 to the second device 204, for example, via the cable 206, or an optical fiber, or even wirelessly, as illustrated in FIG. 2. In the example, each of the three color signals (R), (G) and (B) of the video signal are transmitted by one of the three pairs of wires of the cable 206, respectively. The cable 206 can be a CAT. 5 cable, a CAT. 5e cable, a CAT. 6 cable, a CAT. 6a cable or a CAT. 7 cable, which is available for transmitting video signals in the art.

The multiplexer 306 has a first input port 316a and a second input port 316b. The first input port 316a is arranged to receive the composite sync signal (H+V), and the second input port 314b is arranged to receive the reference signal, which is at a low logic level and provided from the processor 304 in this example. However, the reference signal may be provided by other signal generating source, and its logic level may not be constantly low.

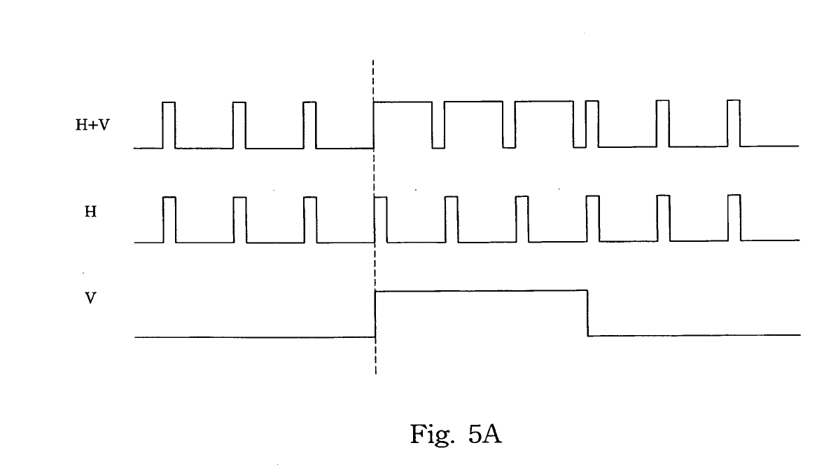

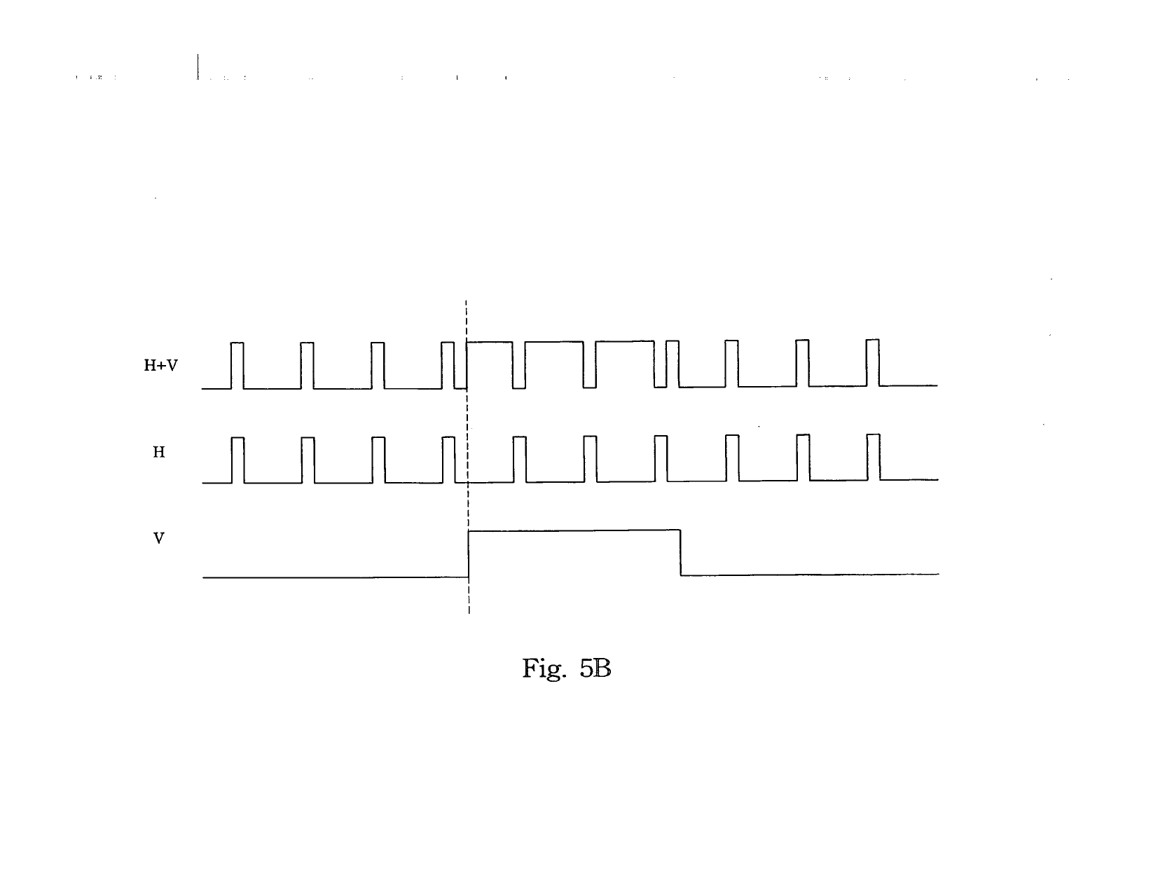

The timing characteristics, which are provided for generating the vertical sync signal (V) and the horizontal sync signal (H), may include rise time, fall time, interval of the composite sync signals (H+V), or their combination, or other suitable timing characteristics. Generally, the composite sync signal (H+V) may have two types depending on its phases of the vertical sync signal (V) and the horizontal sync signal (H). More particularly, as to the composite sync signal (H+V) of the first type that may directly provided by the Sun workstation, the vertical sync signal (V) and the horizontal sync signal (H) are in phase, whose rise times correspondingly match together, as illustrated in FIG. 5A. As to the composite sync signal (H+V) of the second type that may provided from an external video card of the Sun workstation, the vertical sync signal (V) and the horizontal sync signal (H) are out of phase, whose rise times do not correspondingly match, as illustrated in FIG. 5B.

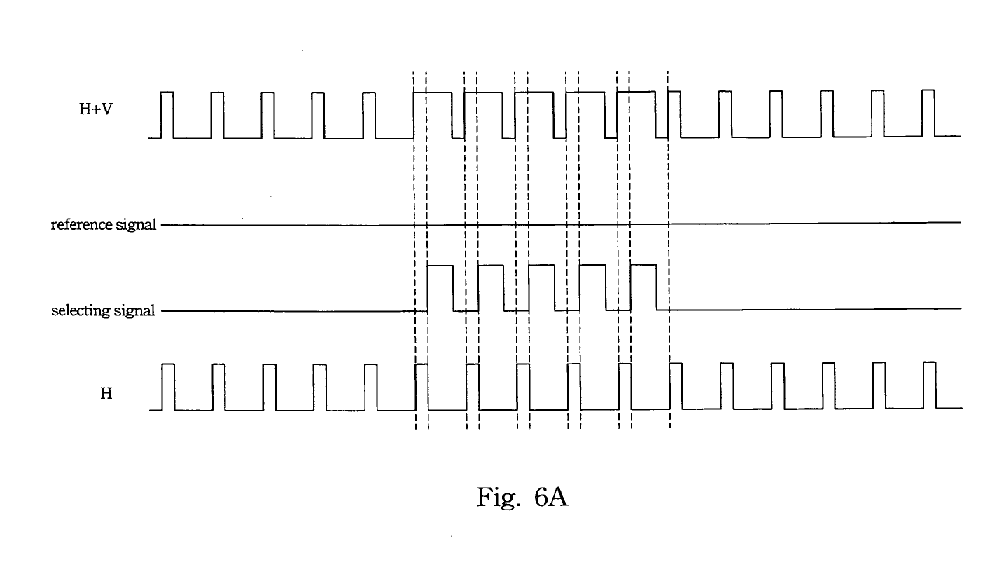

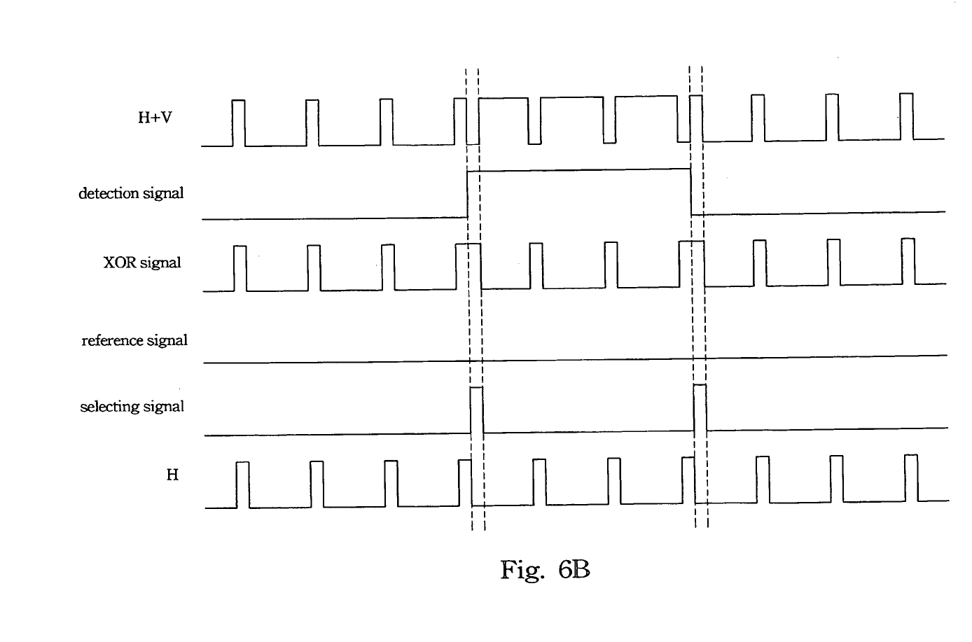

FIG. 6A illustrates the timing diagram of the first-type composite sync signal (H+V), the reference signal, the selecting signal, and the horizontal sync signal (H) generated by the selecting signal according to one example consistent with the present invention. The processor 304 generates the selecting signal as illustrated in FIG. 6A for the first-type composite sync signal (H+V). When the selecting signal is at the first logic level, e.g. a low logic level, the multiplexer 306 outputs the signal received by the first input port 316a, i.e. the composite sync signal (H+V). On the other hand, when the selecting signal is at the second logic level, e.g. a high logic level, the multiplexer 306 outputs the signal received by the second input port 316b, i.e. the reference signal; and therefore generating the horizontal sync signal (H) by selectively outputting the signal received by its two input ports 316a and 316b.

FIG. 6B illustrates the timing diagram of the second-type composite sync signal (H+V), the detection signal, the XOR signal, the reference signal, the selecting signal, and the horizontal sync signal (H) generated by the selecting signal according to one example consistent with the present invention. The apparatus 300 further has a logic gate 308 which is arranged to process the composite sync signal (H+V) with a detection signal before the multiplexer 306 while the horizontal sync signal (H) and the vertical sync signal (V) are out of phase. In the example, the logic gate 308 is a XOR gate which generates an XOR signal of the detection signal and the composite sync signal (H+V). And, the detection signal is generated by the processor 304 with reference to the timing characteristics, such as the rise time, fall time, interval or other suitable timing characteristic, of the composite sync signal (H+V). The XOR signal is inputted into the third input port 316c of the multiplexer 306.

The processor 304 generates the selecting signal as illustrated in FIG. 6B for the second-type composite sync signal (H+V). When the selecting signal is at the first logic level, e.g. a low logic level, the multiplexer 306 outputs the signal inputted into the third input port 316c, i.e. the XOR signal. Oh the other hand, when the selecting signal is at the second logic level, e.g. a high logic level, the multiplexer 306 outputs the signal inputted into the second input port 316b, i.e. the reference signal. Therefore, the horizontal sync signal (H) is generated by selectively outputting the signal received by its two input ports 316c and 316b.

Accordingly, if the vertical sync signal (V) and the horizontal sync signal (H) separated from the composite sync signal (H+V) are in phase, the processor 304 controls the multiplexer 306 with the selecting signal to combine the signals received from the two input ports 316a and 316b. If the vertical sync signal (V) and the horizontal sync signal (H) separated from the composite sync signal (H+V) are out of phase, the processor 304 controls the multiplexer 306 with the selecting signal to combine the signals received from the two input ports 316c and 316b.

The present invention may also be applicable to a video extender or a KVM switch for decoding video signals comprising composite sync signals. The required elements and operations of the decoding process in those applications are identical to the aforementioned descriptions, and therefore will not be described for conciseness.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for decoding a video signal having a composite sync signal, comprising the steps of:
receiving the video signal;
separating the composite sync signal from the video signal;
generating a vertical sync signal and a selecting signal with reference to at least one timing characteristic of the composite sync signal; and
generating a horizontal sync signal by selectively outputting the composite sync signal when the selecting signal is at a first logic level, and outputting a reference signal when the selecting signal is at a second logic level.

2. The method as claimed in claim 1, wherein the at least one timing characteristic is a rise time, fall time, interval of the composite sync signal or combinations thereof.

3. The method as claimed in claim 1, wherein the reference signal is at a low logic level.

4. The method as claimed in claim 1, further comprising:
processing the composite sync signal by a logic gate before selectively outputting while the horizontal sync signal and the vertical sync signal are out of phase.

5. The method as claimed in claim 4, wherein the logic gate is a XOR logic gate.

6. The method as claimed in claim 1, wherein the composite sync signal is received from one pair of wires of a cable.

7. An apparatus for decoding a video signal having a composite sync signal, comprising:
a receiver receiving the video signal and separating the composite sync signal from the video signal;
a processor generating a vertical sync signal and a selecting signal with reference to at least one timing characteristic of the composite sync signal; and
a multiplexer generating a horizontal sync signal by selectively outputting the composite sync signal when the selecting signal is at a first logic level, and outputting a reference signal when the selecting signal is at a second logic level.

8. The apparatus as claimed in claim 7, wherein the at least one timing characteristic is a rise time, fall time, interval of the composite sync signal or combinations thereof.

9. The apparatus as claimed in claim 7, wherein the reference signal is at a low logic level.

10. The apparatus as claimed in claim 7, further comprising:
a logic gate processing the composite sync signal with a detection signal before selectively outputting while the horizontal sync signal and the vertical sync signal are out of phase.

11. The apparatus as claimed in claim 10, wherein the logic gate is a XOR logic gate.

12. The apparatus as claimed in claim 10, wherein the detection signal is generated by the processor with reference to the at least one timing characteristic of the composite sync signal.

13. The apparatus as claimed in claim 7, wherein the composite sync signal is received from one pair of wires of a cable.

14. A KVM switch comprising the apparatus for decoding a video signal having a composite sync signal as in any one of claims 7-13.
